(19) United States
(12) Patent Application Publication
(10) Pub. No.: US 2025/0273362 A1
(43) Pub. Date: Aug. 28, 2025

(54) INSULATED ELECTRIC WIRE AND INFORMATION TRANSMISSION CABLE

(71) Applicant: SUMITOMO ELECTRIC INDUSTRIES, LTD., Osaka (JP)

(72) Inventors: Taro FUJITA, Osaka (JP); Syota MACHINAKA, Osaka (JP); Yuji OCHI, Tochigi (JP); Motoi MATSUDA, Tochigi (JP); Yuto KOBAYASHI, Tochigi (JP); Atsuko SHINOMIYA, Tochigi (JP)

(73) Assignee: SUMITOMO ELECTRIC INDUSTRIES, LTD., Osaka (JP)

(21) Appl. No.: 18/858,307

(22) PCT Filed: Mar. 1, 2023
(86) PCT No.: PCT/JP2023/007537

§ 371 Date: Oct. 19, 2024

(30) Foreign Application Priority Data
May 26, 2022 (JP) 2022-086446

(51) Int. Cl. H01B 3/30; H01B 11/00

(52) U.S. Cl. CPC H01B 3/307; H01B 11/00

(57) ABSTRACT

An insulated wire (1, 11) according to one embodiment of the present disclosure comprises a linear conductor (2) and an insulating layer (3) that is superposed on the outer circumferential surface of the conductor; the insulating layer contains a resin component, an antioxidant and a copper corrosion inhibitors; the resin component is composed of a block polypropylene; the content of ethylene units relative to all monomer units of the resin component is 0.5% by mole to 25.0% by mole; the antioxidant has a hindered phenol structure; the content of the antioxidant is 0.05 part by mass to 0.50 part by mass relative to 100 parts by mass of the resin component; the copper corrosion inhibitors has a triazole structure, a hydrazide structure or a hydrazine structure; and the content of the copper corrosion inhibitors is 0.05 part by mass to 0.50 part by mass relative to 100 parts by mass of the resin component.

### TECHNICAL FIELD

The present disclosure relates to an insulated electric wire and an information transmission cable. This application claims priority based on Japanese Patent Application No. 2022-086446 filed on May 26, 2022, and the entire contents of the Japanese Patent Application are incorporated herein by reference.

### BACKGROUND ART

With the needs for autonomous driving technology and driver assistance functions in automobiles, further increase in the capacity and speed of information transmission is demanded in electric wires for in-vehicle information. In order to increase the speed of signal transmission, it is necessary to reduce the dielectric loss tangent of the insulating layer.

Patent literature 1 (Japanese Unexamined Patent Application Publication No. 2009-81132) discloses an electrical insulation material containing a phenolic antioxidant without a hindered phenol structure. Furthermore, a telecommunication cable using the electrical insulation material as an insulating layer is disclosed.

### CITATION LIST

### Patent Literature

Patent literature 1: Japanese Unexamined Patent Application Publication No. 2009-81132

### SUMMARY OF INVENTION

An insulated electric wire according to an aspect of the present disclosure includes a linear conductor and an insulating layer stacked on an outer peripheral surface of the conductor. The insulating layer includes a resin component, an antioxidant, and a copper corrosion inhibitors. The resin component is a block polypropylene. An ethylene unit content of the resin component is 0.5 mol % to 25.0 mol % relative to total monomeric units. The antioxidant has a hindered phenol structure. A content of the antioxidant is 0.05 parts by mass to 0.50 parts by mass relative to 100 parts by mass of the resin component. The copper corrosion inhibitors has a triazole structure, a hydrazide structure, or a hydrazine structure. A content of the copper corrosion inhibitors is 0.05 parts by mass to 0.50 parts by mass relative to 100 parts by mass of the resin component.

An insulated electric wire according to another aspect of the present disclosure includes a plurality of linear conductors and an insulating layer stacked on an outer peripheral surface of each of the plurality of linear conductors. The insulating layer includes a resin component, an antioxidant, and a copper corrosion inhibitors. The resin component is a block polypropylene. An ethylene unit content of the resin component is 0.5 mol % to 25.0 mol % relative to total monomeric units. The antioxidant has a hindered phenol structure. A content of the antioxidant is 0.05 parts by mass to 0.50 parts by mass relative to 100 parts by mass of the resin component. The copper corrosion inhibitors has a triazole structure, a hydrazide structure, or a hydrazine structure. A content of the copper corrosion inhibitors is 0.05 parts by mass to 0.50 parts by mass relative to 100 parts by mass of the resin component.

### BRIEF DESCRIPTION OF DRAWINGS

FIG. 1 is a schematic cross-sectional view of an insulated electric wire according to an embodiment of the present disclosure.

FIG. 2 is a schematic cross-sectional view of a Twinax cable according to an embodiment of the present disclosure.

FIG. 3 is a schematic perspective view of a coaxial cable according to an embodiment of the present disclosure.

FIG. 4 is a schematic cross-sectional view of the coaxial cable in FIG. 3.

FIG. 5 is a schematic cross-sectional view of a Twinax cable according to another embodiment.

FIG. 6 is a schematic cross-sectional view of a multicore cable according to another embodiment.

### DETAILED DESCRIPTION

### Problems to be Solved by Present Disclosure

Since transmission loss has a positive correlation with the frequency of a signal and the dielectric loss tangent of an insulating layer of a signal transmission cable, in order to increase the speed of signal transmission, it is necessary to reduce the dielectric loss tangent of the insulating layer to reduce the transmission loss, and stably perform the signal transmission. In the above-mentioned conventional technique, when the insulating layer contains an antioxidant or the like, the dielectric loss tangent may be increased. In the electric wires for in-vehicle information, the influence of the dielectric loss tangent on signal attenuation is larger when using as a transmission line. On the other hand, in the insulation material used for the electric wires for in-vehicle information, while heat resistance is provided, a bending property for routing of the electric wires for in-vehicle information is also important.

The present disclosure has been made in view of the above circumstances, and an object of the present disclosure is to provide an insulated electric wire that has heat resistance and is excellent in transmission loss reduction effect and bending property.

### Advantageous Effects of Present Disclosure

According to the present disclosure, it is possible to provide an insulated electric wire that has heat resistance and is excellent in transmission loss reduction effect and bending property.

### DESCRIPTION OF EMBODIMENTS OF PRESENT DISCLOSURE

First, embodiments of the present disclosure will be listed and described.

An insulated electric wire according to an aspect of the present disclosure includes a linear conductor and an insulating layer stacked on an outer peripheral surface of the conductor. The insulating layer includes a resin component, an antioxidant, and a copper corrosion inhibitors. The resin component is a block polypropylene. An ethylene unit content of the resin component is 0.5 mol % to 25.0 mol % relative to total monomeric units. The antioxidant has a hindered phenol structure. A content of the antioxidant is 0.05 parts by mass to 0.50 parts by mass relative to 100 parts by mass of the resin component. The copper corrosion inhibitors has a triazole structure, a hydrazide structure, or a hydrazine structure. A content of the copper corrosion inhibitors is 0.05 parts by mass to 0.50 parts by mass relative to 100 parts by mass of the resin component.

An insulated electric wire according to another aspect of the present disclosure includes a plurality of linear conductors and an insulating layer stacked on an outer peripheral surface of each of the plurality of linear conductors. The insulating layer includes a resin component, an antioxidant, and a copper corrosion inhibitors. The resin component is a block polypropylene. An ethylene unit content of the resin component is 0.5 mol % to 25.0 mol % relative to total monomeric units. The antioxidant has a hindered phenol structure. A content of the antioxidant is 0.05 parts by mass to 0.50 parts by mass relative to 100 parts by mass of the resin component. The copper corrosion inhibitors has a triazole structure, a hydrazide structure, or a hydrazine structure. A content of the copper corrosion inhibitors is 0.05 parts by mass to 0.50 parts by mass relative to 100 parts by mass of the resin component.

In the insulated electric wire, the insulating layer contains block polypropylene as a resin component, and an ethylene unit content of the resin component is 0.5 mol % to 25.0 mol % relative to total monomeric units, so that heat resistance and bending property can be improved. In addition, since the insulating layer contains an antioxidant having a hindered phenol structure, and the content of the antioxidant is within the above range, the effects of suppressing the heat deterioration and the dielectric loss tangent of the resin component is excellent, and heat resistance which is an index of durability of the insulating layer under a high-temperature environment can be improved. Since the insulating layer contains a copper corrosion inhibitors having a triazole structure, a hydrazide structure, or a hydrazine structure, and the content of the copper corrosion inhibitors is within the above range, the effect of suppressing the oxidative deterioration of the resin component of the insulating layer due to copper ions is excellent, and the dielectric loss tangent of the insulating layer can be further reduced. Thus, the insulated electric wire has heat resistance and is excellent in transmission loss reduction effect and bending property. The term “copper induced deterioration” as used herein generally means that an oxidative deterioration of a material is promoted by the catalytic action of a metal in contact with the material. The term “excellent in bending property” means a property that an appearance change such as cracking or whitening is less likely to occur even after bending operations are repeated.

A molecular weight of the antioxidant may be 400 or more. A molecular weight of the copper corrosion inhibitors may be 500 or less. When the molecular weight of the antioxidant is 400 or more, the antioxidation performance is improved, and thus the heat resistance of the insulated electric wire can be improved. In addition, when a molecular weight of the copper corrosion inhibitors is 500 or less, a copper trapping performance is improved, and the oxidative deterioration of the resin component of the insulating layer can be further suppressed. The molecular weights of the antioxidant and the copper corrosion inhibitors can be measured by field desorption mass spectrometry or the like.

A melt flow rate of the insulating layer may be 0.10 g/10 minutes to 10.00 g/10 minutes. When the melt flow rate of the insulating layer is 0.10 g/10 minutes to 10.00 g/10 minutes, the moldability of the insulating layer can be improved. The melt flow rate (MFR) is an index indicating the fluidity of a resin. The MFR is a value measured by a method in accordance with JIS-K7210-1: 2014 (Method A: mass measurement method) using a melt indexer at a measurement temperature of 230° C. and a weight of 2.16 kg.

The insulating layer may have an elastic modulus of 2000 MPa or less at 20° C., an elastic modulus of 1 MPa or more at 150° C., and a dielectric loss tangent of 3.0×10⁻⁴ or less at 10 GHz. When the insulating layer have an elastic modulus of 2000 MPa or less at 20° C., the bending property of the insulating layer can be further improved. When the insulating layer has an elastic modulus of 1 MPa or more at 150° C., the heat resistance of the insulating layer can be further improved. In addition, the insulating layer may have a dielectric loss tangent of 3.0×10⁻⁴ or less when a high-frequency electric field with a frequency of 10 GHz is applied. The dielectric loss tangent of the insulating layer is within the above range when a high-frequency electric field with a frequency of 10 GHz is applied, so that the transmission loss reduction effect can be sufficiently improved.

Here, the term “elastic modulus” is a value measured in accordance with JIS-K7161:2014. Specifically, the elastic modulus refers to the slope of the rising portion of a stress-strain curve (SS curve) when tensile deformation is applied to a strip-shaped conductor and an insulating film using a precision universal tester (tensile tester). In the measurement of the elastic modulus, the sample is pulled at a rate of 50 mm/min with a sample gripping (chucking) interval of the tensile tester set to 50 mm. However, when the elastic modulus of the strip-shaped conductor is measured, a strain gauge capable of measuring a minute displacement is attached to the sample to measure the elastic modulus in consideration of the influence of slippage between the sample and the gripper of the tester. The measurement of elastic modulus directly provides a curve of test force [N] versus moving distance [mm]. As shown in the following Equations (1) and (2), the elastic modulus can be obtained by converting the curve of test force [N] versus moving distance to a curve of stress [Pa] versus strain [%] using the sample size and the chucking interval. In addition, even when the strip-shaped conductor and the insulating film have multilayered structures, the elastic modulus can be obtained by the above-described method. Furthermore, the term “average elastic modulus of a pair of insulating films” means an average of the measured values of elastic modulus of two insulating films. Hereinafter, the term “average thickness” or “elastic modulus” is defined in the same manner.

$$Stress [ Pa ] = test force [ N ] / width [ mm ] / thickness [ mm ] \qquad ( 1 )$$

$$Strain [ \% ] = moving distance [ mm ] / chucking interval [ mm ] \times 100 \qquad ( 2 )$$

Another aspect according to the present disclosure is an information transmission cable including one or a plurality of insulated electric wires each being the insulated electric wire.

The information transmission cable includes the insulated electric wire, and thus has heat resistance, and is excellent in the transmission loss reduction effect and the bending property. Thus, the information transmission cable can have improved durability and transmission performance under a high-temperature environment.

### DETAILS OF EMBODIMENTS OF PRESENT DISCLOSURE

Hereinafter, an insulated electric wire and an information transmission cable according to the embodiment of the present disclosure will be described in detail with reference to the drawings as appropriate.

### <Insulated Electric Wire>

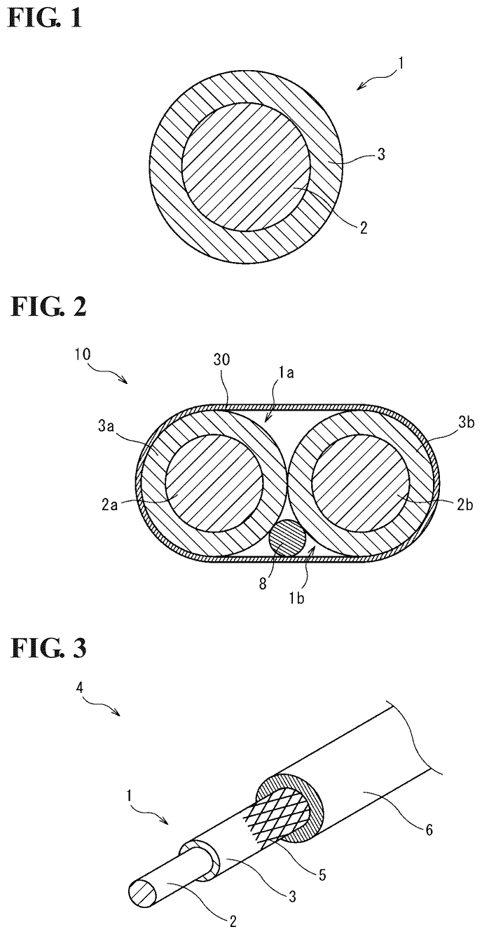

An insulated electric wire includes a linear conductor and an insulating layer stacked on an outer peripheral surface of the conductor. FIG. 1 is a schematic cross-sectional view of an insulated electric wire according to an embodiment of the present disclosure. As shown in FIG. 1, an insulated electric wire 1 includes a linear conductor 2 and one insulating layer 3 stacked on an outer peripheral surface of conductor 2.

### [Conductor]

Conductor 2 is, for example, a round wire having a circular cross section, but may be a square wire having a square cross section, a flat rectangular wire having a rectangular cross section, or a stranded wire obtained by twisting a plurality of element wires together.

The material of conductor 2 may be a metal having a high conductivity and a high mechanical strength. Examples of such a metal include copper, copper alloy, aluminum, aluminum alloy, nickel, silver, soft iron, steel, and stainless steel. Conductor 2 may be a material obtained by forming each of the above-described metals into a linear shape, or a material having a multilayer structure obtained by further coating such a linear material with another metal, such as a nickel clad copper wire, a silver coated copper wire, a copper clad aluminum wire, or a copper clad steel wire.

The lower limit of the average cross-sectional area of conductor 2 may be 0.01 mm² or 0.1 mm². On the other hand, the upper limit of the average cross-sectional area of conductor 2 may be 10 mm² or 5 mm². When the average cross-sectional area of conductor 2 is less than the lower limit, the volume of insulating layer 3 relative to conductor 2 is increased, and the volumetric efficiency of a coil or the like formed using the insulated electric wire may be lowered. To the contrary, when the average cross-sectional area of conductor 2 exceeds the upper limit, insulating layer 3 needs to be formed thick in order to sufficiently decrease the dielectric constant, and the insulated electric wire may have an unnecessarily large diameter. The term “average cross-sectional area” of the conductor means a value obtained by measuring the cross-sectional areas of ten conductors at any position and averaging the cross-sectional areas.

### [Insulating Layer]

Insulating layer 3 is formed on the outer peripheral surface of conductor 2. Insulating layer 3 formed on the outer peripheral surface of conductor 2 may be formed of one insulating layer or two or more insulating layers.

Insulating layer 3 contains a resin component, an antioxidant, and a copper corrosion inhibitors.

The lower limit of the average thickness of insulating layer 3 may be 50 μm or 100 μm. On the other hand, the upper limit of the average thickness of insulating layer 3 may be 1500 μm or 1000 μm. When the average thickness of insulating layer 3 is less than the lower limit, the insulation property may be deteriorated. To the contrary, when the average thickness of insulating layer 3 exceeds the upper limit, the volumetric efficiency of a cable or the like formed using the insulated electric wire may be lowered. The term “average thickness” of the insulating layer means a value obtained by measuring the thicknesses of the insulating layer at any 10 positions and averaging the measured values.

The upper limit of the elastic modulus of insulating layer 3 at 20° C. may be 2000 MPa, 1900 MPa, or 1600 MPa. When insulating layer 3 has an elastic modulus of more than 2000 MPa at 20° C., the flexibility at room temperature may be deteriorated, and the bending property of insulating layer 3 may be deteriorated. On the other hand, the lower limit of the elastic modulus of insulating layer 3 at 20° C. may be 500 MPa or 1000 MPa. When insulating layer 3 has an elastic modulus of less than 500 MPa at 20° C., the heat deformation resistance of insulating layer 3 may be deteriorated.

The lower limit of the elastic modulus of insulating layer 3 at 150° C. may be 1 MPa or 2 MPa. When insulating layer 3 has an elastic modulus of less than 1 MPa at 150° C., the heat deformation resistance of the insulating layer may be deteriorated.

The upper limit of the dielectric loss tangent of the insulating layer when a high-frequency electric field with a frequency of 10 GHz is applied may be 3.0×10⁻⁴ or 2.9×10⁻⁴. When the dielectric loss tangent of the insulating layer is within the above range, the transmission loss reduction effect can be sufficiently improved.

### (Resin Component)

Insulating layer 3 contains block polypropylene as a resin component. In block polypropylene, ethylene-propylene rubber or polyethylene surrounded by ethylene-propylene rubber (hereinafter, referred to as “polyethylene/ethylene-propylene rubber”) is dispersed in homopolypropylene which is a main component. The phase structure is a sea-island structure in which the homopolypropylene corresponds to the sea and the ethylene-propylene rubber or polyethylene/ethylene-propylene rubber corresponds to the island. In the insulated electric wire, the insulating layer contains block polypropylene as a resin component, and thus heat resistance and bending property can be improved. The term “main component” means a component having the highest content.

The lower limit of the melt flow rate (MFR) of insulating layer 3 may be 0.10 g/10 minutes, or may be 0.5 g/10 minutes. On the other hand, the upper limit of the melt flow rate of insulating layer 3 may be 10.00 g/10 minutes or 7.0 g/10 minutes. When insulating layer 3 has a melt flow rate of less than 0.10 g/10 minutes, the moldability may be deteriorated due to a reduced of fluidity. On the other hand, when insulating layer 3 has a melt flow rate of more than 10.00 g/10 minutes, the fluidity becomes too high, and the moldability may be deteriorated.

The lower limit of the ethylene unit content relative to the total monomeric units of the block polypropylene as the resin component may be 0.5 mol %, 1.0 mol %, or 1.5 mol %. On the other hand, the upper limit of the ethylene unit content relative to the total monomeric units of the block polypropylene may be 25.0 mol %, 20.0 mol %, or 18.0 mol %. When the ethylene unit content of the block polypropylene is less than 0.5 mol % relative to total monomeric units, insulating layer 3 becomes too hard, and thus the bending performance may be deteriorated. On the other hand, when the ethylene unit content of the block polypropylene is more than 25.0 mol % relative to the total monomeric units, heat deformation resistance may be deteriorated.

In the block polypropylene, an olefinic thermoplastic elastomer, a styrenic thermoplastic elastomer, an ethylene-propylene rubber, or the like may be added in a range of 1% by mass to 40% by mass in order to improve the bending property.

The lower limit of the content of the resin component in insulating layer 3 may be 95.0% by mass or 98.0% by mass. When the content of the resin component is less than the lower limit, it may be difficult to satisfactorily reduce the dielectric loss tangent of insulating layer 3. On the other hand, the upper limit of the content of the resin component may be 99.95% by mass or 99.90% by mass. When the content of the resin component exceeds the upper limit, the content of the antioxidant or the like in insulating layer 3 is insufficient, and the effect of improving the heat resistance in insulating layer 3 may not be sufficiently high.

Insulating layer 3 may contain a resin other than the resin component (block polypropylene). As the resin other than the resin component, for example, in order to improve workability, polytetrafluoroethylene, an acrylic resin, fluororubber, or the like may be used. The resin other than the resin component may be added in a range of 0.1 parts by mass to 5.0 parts by mass in total with an additive such as an antioxidant or a copper corrosion inhibitors.

### (Antioxidant)

The antioxidant suppresses oxidation of insulating layer 3. The antioxidant has a hindered phenol structure. When the content of the antioxidant of insulating layer 3 increases, the dielectric loss tangent tends to increase. However, since the antioxidant has a hindered phenol structure, high antioxidation performance can be obtained even with a small content, and thus the insulated electric wire has excellent heat resistance. In addition, the insulated electric wire can have a transmission loss reduction effect.

Examples of the antioxidant having a hindered phenol structure include octadecyl 3-(3,5-di-tert-butyl-4-hydroxyphenyl)propionate (molecular weight of 531, “Irganox 1076” manufactured by BASF Japan Ltd.), 1,3,5-tris[[3,5-bis(1,1-dimethylethyl)-4-hydroxy-phenyl]methyl]-1,3,5-triazinane-2,4,6(1H,3H,5H)-trione (molecular weight of 784, “Irganox 3114” manufactured by BASF Japan Ltd.), 2,2′-thiodiethylene bis[3-(3,5-di-tert-butyl-4-hydroxyphenyl)propionate](molecular weight of 643, “Irganox 1035” manufactured by BASF Japan Ltd.), N,N′-(hexane-1,6-diyl)bis[3-(3,5-di-tert-butyl-4-hydroxyphenyl)propanamide] (molecular weight of 637, “Irganox 1098” manufactured by BASF Japan Ltd.), octyl-3,5-di-tert-butyl-4-hydroxyhydrocinnamate (molecular weight of 390, “Irganox 1135” manufactured by BASF Japan Ltd.). The above antioxidants may be used alone or in combination of two or more.

The lower limit of the molecular weight of the antioxidant may be 400 or 500. On the other hand, the upper limit of the molecular weight may be 1500 or 1300. When the molecular weight of the antioxidant is less than the lower limit, the antioxidant is likely to migrate to the surface of the insulating layer and bloom, and due to the decrease in the content rate in the insulating layer, and the antioxidation performance is likely to be lowered. On the other hand, when the molecular weight of the antioxidant exceeds the upper limit, the antioxidant is less likely to move to the oxidative deterioration site of the resin molecule, and the antioxidation performance may be deteriorated.

The lower limit of the content of the antioxidant in insulating layer 3 may be 0.05 parts by mass or 0.10 parts by mass relative to 100 parts by mass of the resin component. When the content of the antioxidant is less than the lower limit, it may be difficult to improve the effect of suppressing heat deterioration of the resin component and an increase in dielectric loss tangent of the resin component. On the other hand, the upper limit of the content of the antioxidant may be 0.50 parts by mass or 0.40 parts by mass relative to 100 parts by mass of the resin component. When the content of the antioxidant exceeds the upper limit, the effect of suppressing an increase in dielectric loss tangent may be lowered, and the transmission performance of the insulated electric wire may be impaired.

### (Copper Corrosion Inhibitors)

The copper corrosion inhibitors stabilizes copper ions by chelate formation and suppresses deterioration of the resin component induced by copper ions, which is so-called copper-induced deterioration. The insulating layer contains a copper corrosion inhibitors, and thus copper-induced deterioration can be suppressed to reduce copper-induced deterioration of the resin component. Thus, the dielectric loss tangent of the insulating layer can be further reduced. The copper corrosion inhibitors has a triazole structure, a hydrazide structure, or a hydrazine structure. When the copper corrosion inhibitors has a triazole structure, a hydrazide structure, or a hydrazine structure, the copper corrosion inhibitors has an excellent effect of suppressing the copper-induced deterioration.

An example of the copper corrosion inhibitors having the triazole structure include a composite substance (product name: ADK STAB CDA-1M, molecular weight 204) containing 2-hydroxy-N-1H-1,2,4-triazol-3-ylbenzamide as a main component. Examples of the copper corrosion inhibitors having the hydrazide structure include decamethylene dicarboxylic acid disalicyloyl hydrazide (product name: ADK STAB CDA-6S, molecular weight of 499), isophthalic acid bis(2-phenoxypropionyl hydrazide) (product name: CUNOX, molecular weight of 491), and the like. Examples of the copper corrosion inhibitors having a hydrazine structure include N,N′-bis[3-(3,5-di-tert-butyl-4-hydroxyphenyl)propionyl]hydrazine (product name: Irganox MD1024, molecular weight of 553), 1,2-bis(3,5-di-tert-butyl-4-hydroxyhydrocinnamoyl)hydrazine (product name: ADK STAB CDA-10, molecular weight of 553). The copper corrosion inhibitors described above may be used alone or in combination of two or more.

The upper limit of the molecular weight of the content of the copper corrosion inhibitors may be 500 or 400. On the other hand, the lower limit of the molecular weight may be 100 or 200. When the molecular weight of the copper corrosion inhibitors is less than the lower limit, the copper corrosion inhibitors is likely to migrate to the surface of insulating layer 3, and the copper trapping performance may be likely to be reduced. On the other hand, when the molecular weight of the copper corrosion inhibitors exceeds the upper limit, the copper corrosion inhibitors is less likely to migrate in insulating layer 3, and the copper trapping performance may be likely to be reduced.

The lower limit of the content of the copper corrosion inhibitors in insulating layer 3 may be 0.05 parts by mass or 0.1 parts by mass relative to 100 parts by mass of the resin component. When the content of the copper corrosion inhibitors is less than the lower limit, it may be difficult to improve the effect of suppressing the copper-induced deterioration. On the other hand, the upper limit of the content of the copper corrosion inhibitors may be 0.50 parts by mass or 0.40 parts by mass relative to 100 parts by mass of the resin component. When the content of the copper corrosion inhibitors exceeds the upper limit, an additive in insulating layer 3 may be deposited onto the surface from the resin and crystallized, that is, a so-called bloom may be generated, and the quality of insulating layer 3 may be impaired.

### (Other Components)

Insulating layer 3 may contain, for example, a flame retardant, a flame retardant aid, a pigment, and the like as other components in addition to the resin component, the antioxidant, and the copper corrosion inhibitors.

The flame retardant provides insulating layer 3 with flame resistance. Examples of the flame retardant include halogen flame retardants such as a chlorinated flame retardant and a brominated flame retardant, as well as halogen-free flame retardants such as metal hydroxides, for example, magnesium hydroxide.

The flame retardant aid is used to further improve the flame resistance of insulating layer 3. Examples of the flame retardant aid include antimony trioxide, for example.

The pigment is used to color insulating layer 3. As the pigment, various known pigments may be used, and examples thereof include titanium oxide, for example.

### [Method of Manufacturing Insulated Electric Wire]

Next, a method of manufacturing the insulated electric wire will be described. In the insulated electric wire, insulating layer 3 is formed by extrusion molding. The method of manufacturing the insulated electric wire includes a process (extrusion process) in which the resin composition for forming the insulating layer is extrusion-coated on the outer peripheral surface of conductor 2. The resin composition for forming the insulating layer has the same configuration as the insulating layer described above, and thus the description thereof will be omitted.

The insulated electric wire has heat resistance and is excellent in transmission loss reduction effect and bending property.

### <Information Transmission Cable>

The information transmission cable includes one or more insulated electric wires that are each the insulated electric wire described above. Examples of the information transmission cable include a differential-signal transmission cable and a coaxial cable, for example.

### [Differential-Signal Transmission Cable]

The differential-signal transmission cable is suitably used as a cable for transmitting a differential signal in a field where high-speed communication is needed. Examples of the differential-signal transmission cable include a Twinax cable having a Twinax construction, for example.

FIG. 2 is a schematic cross-sectional view of a Twinax cable, which is one embodiment of the information transmission cable. As shown in FIG. 2, a Twinax cable 10 has a Twinax construction having a pair of insulated electric wires formed of a first insulated electric wire 1a and a second insulated electric wire 1b. First insulated electric wire 1a includes a first linear conductor 2a and one first insulating layer 3a stacked on the outer peripheral surface of first conductor 2a. Second insulated electric wire 1b includes a second liner conductor 2b and one second insulating layer 3b stacked on the outer peripheral surface of second conductor 2b. The insulated electric wire is used as first insulated electric wire 1a and second insulated electric wire 1b. In addition, Twinax cable 10 includes a drain wire 8 serving as a third conductor, and a shielding tape 30 disposed to cover first insulated electric wire 1a, second insulated electric wire 1b, and drain wire 8.

When a Twinax cable is used as the information transmission cable, signal transmission at a high accuracy and a high speed can be performed efficiently. Drain wire 8 is grounded, so that Twinax cable 10 can be prevented from being charged. Furthermore, by including shielding tape 30, it is possible to suppress the interference of an electromagnetic noise from the outside and to reduce the mutual interference between first conductor 2a and second conductor 2b in the pair of insulated electric wires.

Shielding tape 30 is formed by providing a conductive layer on one surface of an insulating film made of a resin such as polyvinyl chloride, flame retardant polyolefin, or polyester. As shielding tape 30, a tape-shaped material such as copper deposited polyethylene terephthalate (PET), for example, may be used. In the present embodiment, shielding tape 30 is disposed so as to cover the outer peripheries of first insulating layer 3a and second insulating layer 3b. Shielding tape 30 is disposed on the outer peripheries of first insulating layer 3a and second insulating layer 3b so as to relatively fix the positional relationship between first insulated electric wire 1a and second insulated electric wire 1b while wrapping first insulated electric wire 1a, second insulated electric wire 1b, and drain wire 8.

### [Method of Manufacturing Twinax Cable]

In a method of manufacturing a Twinax cable which is one embodiment of the information transmission cable, for example, a first insulated electric wire and a second insulated electric wire are bundled, a drain wire is disposed, and a shielding tape is wound around the outer periphery thereof, thereby manufacturing the Twinax cable.

### [Coaxial Cable]

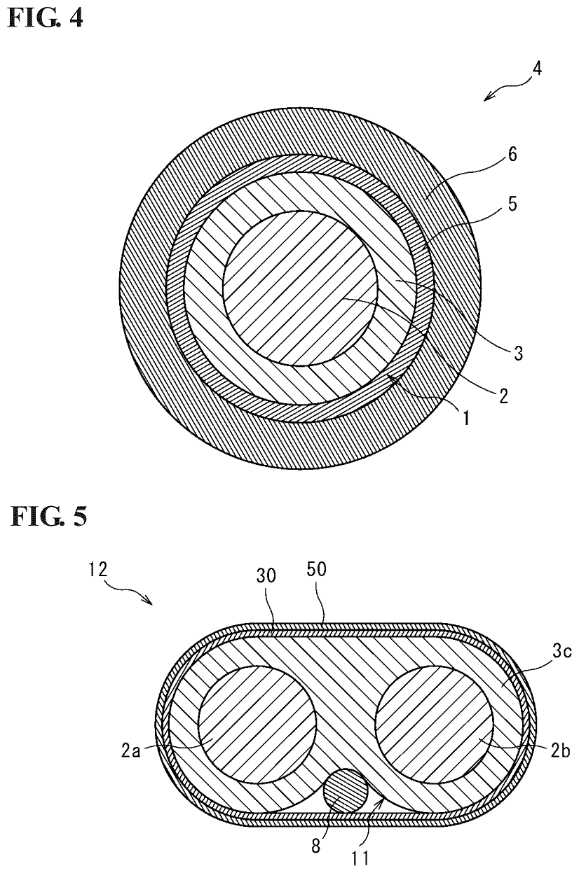

A coaxial cable, which is an embodiment of the information transmission cable, includes the insulated electric wire described above, an external conductor covering a peripheral surface of the insulated electric wire, and a jacket layer covering a peripheral surface of the external conductor. The insulated electric wire includes one conductor and one insulating layer covering a peripheral surface of the conductor. An embodiment of the coaxial cable will be described with reference to FIG. 3 and FIG. 4.

A coaxial cable 4 in FIG. 3 and FIG. 4 includes insulated electric wire 1 including conductor 2 and insulating layer 3 covering a peripheral surface of conductor 2, an external conductor 5 covering a peripheral surface of insulated electric wire 1, and a jacket layer 6 covering a peripheral surface of external conductor 5. That is, coaxial cable 4 has a configuration in which conductor 2, insulating layer 3, external conductor 5, and jacket layer 6 are concentrically stacked in a cross-sectional shape. Since the information transmission cable is coaxial cable 4, the diameter of the information transmission cable can be reduced. Insulated electric wire 1, conductor 2, and insulating layer 3 are the same as those of insulated electric wire 1 in FIG. 1, and thus denoted by the same reference numerals, and the description thereof is omitted.

External conductor 5 serves as a ground and functions as a shield for preventing electrical interference from other circuits. External conductor 5 covers the outer surface of insulating layer 3. Examples of external conductor 5 include braided shield, spiral shield, tape shield, conductive plastic shield, and metal tube shield and the like. Among these, from the viewpoint of high-frequency shielding property, braided shield and tape shield are preferable. When braided shield or metal tube shield is used as external conductor 5, the number of shields may be appropriately determined based on the shield to be used or the intended shielding property, and the shield may be a single shield or multiple shields such as double shields or triple shields.

Jacket layer 6 protects conductor 2 and external conductor 5, and provides functions such as flame resistance and weather resistance in addition to insulation property. Jacket layer 6 contains a thermoplastic resin as a main component.

Examples of the thermoplastic resin include polyvinyl chloride, olefinic resins such as low-density polyethylene, high-density polyethylene, expanded polyethylene, and polypropylene, polyurethane, and fluororesin. Among these, olefinic resin and polyvinyl chloride are preferable from the viewpoint of cost and easy processability. The thermoplastic resins exemplified above may be used alone or in combination of two or more, and may be appropriately selected based on the functions to be achieved by jacket layer 6.

### [Method of Manufacturing Coaxial Cable]

Coaxial cable 4 is formed by covering insulated electric wire 1 with external conductor 5 and jacket layer 6.

External conductor 5 can be covered by a known method suitable for the shielding method to be applied. For example, the braided shield can be formed by inserting insulated electric wire 1 into a tube-shaped braid and then reducing the diameter of the braid. The spiral shield can be formed by winding a metal wire such as a copper wire around insulating layer 3. The tape shield can be formed by winding a conductive tape such as an aluminum/polyester laminate tape around insulating layer 3.

The covering with jacket layer 6 can be performed by the same method as the covering of conductor 2 with insulating layer 3 in insulated electric wire 1. The thermoplastic resin or the like may be applied to the peripheral surfaces of insulated electric wire 1 and external conductor 5.

The information transmission cable includes the insulated electric wire, and thus has heat resistance, and is excellent in transmission loss reduction effect and the bending property. Thus, the information transmission cable can have improved durability and transmission performance under a high-temperature environment.

### OTHER EMBODIMENTS

It should be understood that the embodiments disclosed herein are illustrative and non-restrictive in all respects. The scope of the present invention is not limited to the configurations of the above-described embodiments, but is defined by the scope of claims, and is intended to include all modifications within the meaning and scope equivalent to the scope of claims.

For example, in the above embodiment, Twinax cable 10 including a pair of insulated electric wires in which a pair of conductors are covered with a pair of insulating layers as shown in FIG. 2 is exemplified as an information transmission cable, but a Twinax cable 12 as shown in FIG. 5 can be exemplified as a Twinax cable. Twinax cable 12 in FIG. 5 includes one insulated electric wire in which a pair of conductors are covered with one insulating layer. Twinax cable 12 will be described below.

Twinax cable 12 is different from Twinax cable 10 in that a third insulating layer 3c is integrally formed so as to cover the peripheral surfaces of both first conductor 2a and second conductor 2b to form one insulated electric wire 11, shielding tape 30 is disposed on the outer peripheries of insulated electric wire 11 and drain wire 8, and a jacket layer (sheath layer) 50 is provided as an outer surface layer. In Twinax cable 12, the same components as those of Twinax cable 10 are denoted by the same reference numerals, and the description thereof will be omitted.

As shown in FIG. 5, Twinax cable 12 includes first liner conductor 2a, second liner conductor 2b, third insulating layer 3c, drain wire 8, shielding tape 30, and jacket layer 50. In Twinax cable 12, the insulating layer is integrally formed, and third insulating layer 3c is disposed so as to cover the peripheral surfaces of first conductor 2a and second conductor 2b. Shielding tape 30 is disposed so as to cover insulated electric wire 11 and drain wire 8.

Jacket layer 50 is disposed so as to cover an outer peripheral surface of shielding tape 30. First conductor 2a, second conductor 2b, and drain wire 8 are protected by jacket layer 50 without being exposed to the external environment. By providing jacket layer 50 as described above, durability, weather resistance, flame resistance, and the like of Twinax cable 12 are enhanced. Furthermore, jacket layer 50 is provided, and thus shape retention property of Twinax construction is improved. From this point of view, it is preferable for Twinax cable 12 to have jacket layer 50.

Third insulating layer 3c is formed, for example, as follows. That is, the resin composition for insulating layer for forming third insulating layer 3c is extrusion molded while first conductor 2a and second conductor 2b are conveyed with first conductor 2a and second conductor 2b disposed in parallel. By extrusion molding, third insulating layer 3c formed to cover the peripheral surfaces of both first conductor 2a and second conductor 2b is obtained.

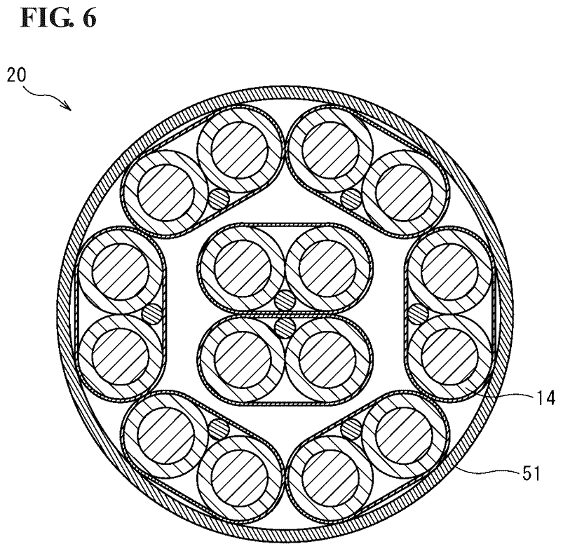

The information transmission cable may be a multicore cable in which a plurality of Twinax cables are further covered with a jacket layer. Since the information transmission cable is such a multicore cable, the information transmission cable can transmit a larger capacity signal than a Twinax cable. As such a multicore cable, for example, a multicore cable 20 as shown in FIG. 6 is exemplified. Multicore cable 20 in FIG. 6 includes a plurality of subunits 14 and a jacket layer 51 covering the plurality of subunits 14, and each of subunits 14 is a Twinax cable. Jacket layer 51 may have the same structure as jacket layer 51 described above. In the embodiment shown in FIG. 6, the above-described Twinax cable 10 is used as each of subunits 14. Each of subunits 14 is not limited to Twinax cable 10, and may be Twinax cable 12 described above or the like.

The insulated electric wire may have an insulating layer that is foamed. Foaming the insulating layer can lower a dielectric constant, and the insulating layer can be made thinner to meet a predetermined characteristic impedance (50Ω, 100Ω, etc.), thereby enabling the cable to be made thinner.

The conductor can be formed of a stranded wire in which a plurality of metal wires are twisted together. In this case, a plurality of types of metal wires may be combined. The number of twists is generally seven or more.

The insulated electric wire may have a primer layer directly stacked on the conductor. As the primer layer, a layer obtained by crosslinking a resin such as ethylene containing no metal hydroxide may be suitably used. By providing such a primer layer, it is possible to suppress deterioration over time in the peelability between the insulating layer and the conductor, and to suppress the reduction of the efficiency of wire connection work.

### EXAMPLE

The present invention will be described in more detail with reference to the following experimental examples, but the present invention is not limited to the following experimental examples.

### [Insulating Layers No. 1 to No. 18]

The insulating resin compositions used for the insulating layers No. 1 to No. 18 were obtained by mixing the resin component, the antioxidant, and the copper corrosion inhibitors shown below so that the respective contents (parts by mass) were as shown in Table 1. The resin compositions for insulating layer were press-molded to produce sheet-shaped insulating layers No. 1 to No. 18. The press molding was performed by preheating at 180° C. for 5 minutes, further pressurizing at the same temperature, holding for 5 minutes, cooling to room temperature, and then taking out the press-molded resin composition. No. 14 was further subjected to electron beam crosslinking at an irradiation dose of 200 kGy.

### (Resin Component)

(1) Block polypropylene A (ethylene unit content of 12.0 mol %)
(2) Block polypropylene B (ethylene unit content of 1.5 mol %)
(3) Block polypropylene C (ethylene unit content of 18.0 mol %)
(4) Block polypropylene D (ethylene unit content of 0.1 mol %)
(5) Block polypropylene E (ethylene unit content of 26.0 mol %)
(6) Homopolypropylene (ethylene unit content of 0 mol %)
(7) Random polypropylene (ethylene unit content of 21.0 mol %)
(8) Polyethylene (ethylene unit content of 95.0 mol %)

### (Antioxidant)

(1) “Irganox 1076” manufactured by BASF Japan Ltd.
Hindered phenol antioxidant (molecular weight of 531)
Octadecyl 3-(3,5-di-tert-butyl-4-hydroxyphenyl)propionate
(2) “Irganox 1135” manufactured by BASF Japan Ltd.
Hindered phenol antioxidant (molecular weight of 390)
Octyl-3,5-di-tert-butyl-4-hydroxyhydrocinnamate

### (Copper Corrosion Inhibitors)

(1) “ADK STAB CDA-6S” manufactured by ADEKA CORPORATION.
Copper corrosion inhibitors having a hydrazide structure (molecular weight of 499)
Decamethylene dicarboxylic acid disalicyloyl hydrazide
(2) ADK STAB CDA-10 manufactured by ADEKA CORPORATION.
Copper corrosion inhibitors having a hydrazine structure (molecular weight of 553)
1,2-Bis(3,5-di-tert-butyl-4-hydroxyhydrocinnamoyl)hydrazine

### [Insulated Electric Wire No. 1 to No. 18]

Insulated electric wires and Twinax cables having outer diameters shown in Table 1 were produced by the following procedure using insulating layers No. 1 to No. 18. The antioxidant and the copper corrosion inhibitors were kneaded into the resin component shown in Table 1 by a roll kneader (set temperature of 180° C.), and the kneaded mixture was taken out in a strip shape and cut into pellets to prepare a resin composition. An insulated wire in which an insulating layer had an outer diameter of 1.6 mmϕ was produced by coating a tinned annealed copper wire having a diameter of 0.45 mmϕ with the resin composition having a thickness of 0.575 mm by using a 50 mmϕ extruder with a 2.0 mmϕ die and a 0.6 mmϕ point at a line speed of 50 mm/min. Subsequently, two insulated electric wires thus produced were bundled, a drain wire (tinned annealed copper wire having a diameter of 0.30 mmϕ) was disposed, and a shielding tape was wound around the outer periphery thereof, thereby obtaining a Twinax cable having a Twinax construction shown in FIG. 2. As the shielding tape, an aluminum-deposited PET tape was used.

### <Evaluation>

The insulated electric wires and Twinax cables including insulating layers No. 1 to No. 18 obtained as described above were evaluated.

### (Melt Flow Rate of Insulating Layer)

The portion of the insulating layer was peeled off from each insulated electric wire, and the melt flow rate of the insulating layer was measured using a melt indexer by a method in accordance with JIS-K7210-1:2014 (Method A: mass measurement method) at a measurement temperature of 230° C. and a weight of 2.16 kg.

### (Extrusion Processability)

The extrusion processability was measured by extruding the insulating layer at a line speed of 50 mm/min using an extruder, and measuring the variation in the outer diameter of the insulating layer. An insulating layer having an outer diameter within a range of 1.6 mmϕ±10% was rated as “A” (acceptable), and an insulating layer having an outer diameter out of a range of 1.6 mmϕ±10% or exceeding an upper pressure limit of the extruder during extrusion was rated as “B” (unacceptable).

### (Elastic Modulus)

The elastic modulus [Mpa] at 20° C. was evaluated by measuring the slope of the rising portion of the SS curve using a tensile tester as described above. The elastic modulus [Mpa] at 150° C. was evaluated by measuring the slope of the rising portion of the SS curve using a tensile tester equipped with a thermostatic bath.

### (Dielectric Loss Tangent)

Sheet-shaped samples were prepared for insulating layers No. 1 to No. 18. The dielectric loss tangent (tan σ) when a high-frequency electric field with a frequency of 10 GHz was applied was measured by a method in accordance with JIS-R1641 (2007). The measurement was performed three times, and the average value was obtained.

### (Transmission Loss)

The transmission loss [dB/m] of each of Twinax cables No. 1 to No. 18 was measured using a network analyzer. A Twinax cable whose transmission loss fell within −4.0 dB/m was rated as “A” (acceptable), and a Twinax cable whose transmission loss did not fall within −4.0 dB/m was evaluated as “B” (unacceptable).

### (Heat Deformation Resistance Test)

Insulated electric wires No. 1 to No. 18 were stored for 100 hours in an environment at a temperature of 150° C., and then the transmission loss was measured using a network analyzer. The evaluation criteria for short-term heat resistance (at 150° C. for 100 hours) was as follows: a transmission loss deterioration rate of 10% or less was rated as “A” (acceptable), and a transmission loss deterioration rate of more than 10% was rated as “B” (unacceptable).

### (Long-Term Heat Resistance Test)

### (1) Long-Term Heat Resistance (at 105° C. for 10000 Hours)

Insulated electric wires No. 1 to No. 18 were subjected to a long-term heat resistance test in accordance with the JASO D611 standard, using the following procedure. Each tubular insulating layer was obtained for evaluation by pulling the conductor out of each insulated electric wire. After each tubular insulating layer was stored for 10000 hours in a thermostatic bath set at 105° C., the time until the tensile elongation was less than 100% was determined as a life time. Arrhenius plot was performed based on the results to estimate the temperature at which the tensile elongation reached 100% in an aging test for 10000 hours, and the estimated temperature was used as a 10000-hour heat resistance temperature. The evaluation criteria for long-term heat resistance (at 105° C. for 10000 hours) were as follows: a heat resistance temperature of 105° C. or more was rated as “A”, a heat resistance temperature of 100° C. or higher was rated as “B”, and a heat resistance temperature of less than 100° C. was rated as “C”, and “A” and “B” are considered acceptable.

### (2) Long-Term Heat Resistance (at 100° C. for 3000 Hours)

Insulated electric wires No. 1 to No. 18 were subjected to a long-term heat resistance test in accordance with the JASO-D611 standard, using the following procedure. The long-term heat resistance (at 100° C. for 3000 hours) of insulated electric wires No. 1 to No. 18 was evaluated in accordance with Long Term Heat Ageing CLASS B (100° C. for 3000 hours) of ISO 6722-1 (2011). Specifically, the insulated electric wire was stored for 3000 hours in a thermostatic bath set at 100° C., and then wound three times around a metal mandrel having a diameter 1.5 times the outer diameter of the insulated electric wire. An insulated electric wire that did not have any exposed conductor due to cracking of the insulating layer and passed a breakdown test (at 1 kV for 1 minute after immersion in a salt water for 10 minutes) was rated as “A”, an insulated electric wire that did not have any exposed conductor but broke in the breakdown test was rated as “B”, and an insulated electric wire that had an exposed conductor was rated as “C”, and “A” is considered acceptable.

### (Bending Performance)

The bending performance was evaluated by mounting a jig for a compression test in a tensile test, fixing the insulated electric wires No. 1 to No. 18 to the jig, and measuring reaction forces when the insulated electric wires were bent at a bending radius of 25 mm. The evaluation criteria for bending performance was as follows: a sample having a bending reaction force of 1 N or less was rated as “A” (acceptable), and a sample having a bending reaction force exceeding 1 N was rated as “B” (unacceptable).

The results of the dielectric loss tangent measurement and the heat aging resistance test are shown in Table 1.

TABLE 1

| TEST No. | | | No. 1 | No. 2 | No. 3 | No. 4 | No. 5 | No. 6 | No. 7 | No. 8 | No. 9 | No. 10 | No. 11 |
|---|---|---|---|---|---|---|---|---|---|---|---|---|---|
| INSULATING | RESIN | BLOCK POLYPROPYLENE A | 100 | 100 | 100 | — | — | 100 | 100 | 100 | 100 | 100 | 100 |
| LAYER | COMPONENT | BLOCK POLYPROPYLENE B | — | — | — | 100 | — | — | — | — | — | — | — |
| COMPOSITION | [PARTS | BLOCK POLYPROPYLENE C | — | — | — | — | 100 | — | — | — | — | — | — |
| | BY MASS] | BLOCK POLYPROPYLENE D | — | — | — | — | — | — | — | — | — | — | — |
| | | BLOCK POLYPROPYLENE E | — | — | — | — | — | — | — | — | — | — | — |
| | | HOMOPOLYPROPYLENE | — | — | — | — | — | — | — | — | — | — | — |
| | | RANDOM POLYPROPYLENE | — | — | — | — | — | — | — | — | — | — | — |
| | | POLYETHYLENE | — | — | — | — | — | — | — | — | — | — | — |
| | | ETHYLENE UNIT CONTENT RELATIVE | 12.0 | 12.0 | 12.0 | 1.5 | 18.0 | 12.0 | 12.0 | 12.0 | 12.0 | 12.0 | 12.0 |
| | | TO TOTAL MONOMERIC UNITS [mol %] | | | | | | | | | | | |
| | ANTIOXIDANT | HINDERED PHENOL: IRGANOX 107 [symbol] , | 0.06 | 0.20 | 0.40 | 0.40 | 0.40 | 0.40 | 0.40 | — | 0.40 | 0.40 | 0.40 |
| | [PARTS | MOLECULAR WEIGHT 531 | | | | | | | | | | | |
| | BY MASS] | IRGANOX 1135, | — | — | — | — | — | — | — | 0.40 | — | — | — |
| | | MOLECULAR WEIGHT 3 [symbol] 0 | | | | | | | | | | | |
| | COPPER | ADK STAB CDA- [symbol] | 0.06 | 0.20 | 0.40 | 0.40 | 0.40 | 0.40 | 0.40 | 0.40 | — | 0.40 | 0.40 |
| | CORROSION | MOLECULAR WEIGHT 498 | | | | | | | | | | | |
| | INHIBITORS | ADK STAB CDA-10, | — | — | — | — | — | — | — | — | 0.40 | — | — |
| | [PARTS | MOLECULAR WEIGHT [symbol] | | | | | | | | | | | |
| | BY MASS] | | | | | | | | | | | | |

| | | | | | | | | | | | | |
|---|---|---|---|---|---|---|---|---|---|---|---|---|
| | PRESENCE OF CROSSLINKING | NO | NO | NO | NO | NO | NO | NO | NO | NO | NO | NO |
| | MFR OF INSULATING LAYER [g/10 min] | 1.00 | 1.00 | 1.00 | 0.70 | 1.10 | 0.20 | 4.00 | 1.00 | 1.00 | 0.05 | 7.00 |
| ELECTRIC WIRE | OUTER DIAMETER OF INSULATED ELECTRIC WIRE [mm [symbol] ] | 1.6 | 1.6 | 1.6 | 1.6 | 1.6 | 1.6 | 1.6 | 1.6 | 1.6 | 1.6 | 1.6 |
| | OUTER DIAMETER OF CONDUCTOR [mm [symbol] ] | 0.45 | 0.45 | 0.45 | 0.45 | 0.45 | 0.45 | 0.45 | 0.45 | 0.45 | 0.45 | 0.45 |
| EXTRUSION | OUTER DIAMETER VARIATION OF INSULATING | A | A | A | A | A | A | A | A | A | B | B |
| PROCESSABILITY | LAYER AND EXTRUDER PRESSURE IN | | | | | | | | | | (ALMOST | (SLIGHTLY |
| | EXTRUSION AT LINE SPEED OF [symbol] mm/min | | | | | | | | | | UPPER | LARGE |
| | | | | | | | | | | | LIMIT OF | OUTER |
| | | | | | | | | | | | EXTRUDER | DIAMETER |
| | | | | | | | | | | | PRESSURE) | VARIATION) |
| INSULATING | ELASTIC MODULUS (20° C.) [Mpa] | 1500 | 1500 | 1500 | 1900 | 1000 | 1500 | 1500 | 1500 | 1500 | 1500 | 1500 |
| LAYER | ELASTIC MODULUS (150° C.) [Mpa] | 120 | 120 | 120 | 140 | 2 | 130 | 100 | 100 | 100 | 140 | 70 |
| PERFORMANCE | DIERECTRIC LOSS TANGENT (tan [symbol] ) | 1.8 × | 2.2 × | 2.8 × | 2.7 × | 2.8 × | 2.6 × | 2.8 × | 2.9 × | 2.7 × | 2.8 × | 2.8 × |
| | | 10 [symbol] | 10 [symbol] | 10 [symbol] | 10 [symbol] | 10 [symbol] | 10 [symbol] | 10 [symbol] | 10 [symbol] | 10 [symbol] | 10 [symbol] | 10 [symbol] |
| ELECTRIC WIRE | LONG-TERM HEAT RESISTANCE (10000 hours) [° C.] | 108 A | 111 A | 112 A | 109 A | 112 A | 113 A | 107 A | 101 A | 105 A | 113 A | 107 A |
| PERFORMANCE | LONG-TERM HEAT RESISTANCE (3000 hours) [° C.] | A | A | A | A | A | A | A | A | A | A | A |
| | BENDING PERFORMANCE [N] | 0.84 | 0.82 | 0.85 | 0.93 | 0.61 | 0.84 | 0.84 | 0.82 | 0.83 | 0.44 | 0.45 |
| | | A | A | A | A | A | A | A | A | A | A | A |
| CABLE | TRANSMISSION LOSS [dB/m] | −3.1 | −3.4 | −3.9 | −3.9 | −3.8 | −3.6 | −3.7 | −3.8 | −3.6 | −3.8 | −3.7 |
| PERFORMANCE | | A | A | A | A | A | A | A | A | A | A | A |
| | HEAT DEFORMATION RESISTANCE (150° C.) [%] | 2 | 3 | 2 | 1 | 8 | 1 | 3 | 4 | 4 | 1 | [symbol] |
| | | A | A | A | A | A | A | A | A | A | A | A |

[symbol]

indicates data missing or illegible when filed

TABLE 2

| | | | No. | No. | No. | No. | No. | No. | No. |
|---|---|---|---|---|---|---|---|---|---|
| TEST No. | | | 12 | 13 | 14 | 15 | 16 | 17 | 18 |
| INSULATING | RESIN | BLOCK POLYPROPYLENE A | 100 | 100 | — | — | — | — | — |
| LAYER | COMPONENT | BLOCK POLYPROPYLENE B | — | — | — | — | — | — | — |
| COMPOSITION | [PARTS | BLOCK POLYPROPYLENE C | — | — | — | — | — | — | — |
| | BY MASS] | BLOCK POLYPROPYLENE D | — | — | 100 | — | — | — | — |
| | | BLOCK POLYPROPYLENE E | — | — | — | 100 | — | — | — |
| | | HOMOPOLYPROPYLENE | — | — | — | — | 100 | — | — |
| | | RANDOM POLYPROPYLENE | — | — | — | — | — | 100 | — |
| | | POLYETHYLENE | — | — | — | — | — | — | 100 |
| | | ETHYLENE UNIT CONTENT | 12.0 | 12.0 | 0.1 | 26.0 | 0.0 | 21.0 | 95.0 |
| | | RELATIVE TO TOTAL | | | | | | | |
| | | MONOMERIC UNITS (mol %) | | | | | | | |
| | ANTIOXIDANT | HINDERED PHENOL: | 0.03 | 0.60 | 0.40 | 0.40 | 0.40 | 0.40 | 0.40 |
| | [PARTS | IRGANOX 1076, | | | | | | | |
| | BY MASS] | MOLECULAR WEIGHT 531 | | | | | | | |
| | | IRGANOX 113 [symbol] , | — | — | — | — | — | — | — |
| | | MOLECULAR WEIGHT 390 | | | | | | | |
| | COPPER | ADK STAB CDA-68 | 0.03 | 0.60 | 0.40 | 0.40 | 0.40 | 0.40 | 0.40 |
| | CORROSION | MOLECULAR WEIGHT 489 | | | | | | | |
| | INHIBITORS | ADK STAB CDA-10, | — | — | — | — | — | — | — |
| | [PARTS | MOLECULAR WEIGHT 653 | | | | | | | |
| | BY MASS] | | | | | | | | |

| | PRESENCE OF CROSSLINKING | NO | NO | NO | NO | NO | NO | YES |
|---|---|---|---|---|---|---|---|---|
| | MFR OF INSULATING | 1.00 | 1.00 | 0.80 | 1.00 | 1.00 | 1.10 | 2.20 |
| | LAYER [g/10 min] | | | | | | | |
| ELECTRIC | OUTER DIAMETER OF INSULATED | 1.6 | 1.6 | 1.6 | 1.6 | 1.6 | 1.6 | 1.6 |
| WIRE | ELECTRIC WIRE(mm [symbol] ) | | | | | | | |
| | OUTER DIAMETER OF | 0.45 | 0.45 | 0.45 | 0.45 | 0.45 | 0.45 | 0.45 |
| | CONDUCTOR(mm [symbol] ) | | | | | | | |
| EXTRUSION | OUTER DIAMETER VARIATION OF | A | A | A | A | A | A | A |
| PROCESSABILITY | INSULATING LAYER AND EXTRUDER | | | | | | | |
| | PRESSURE IN EXTRUSION AT | | | | | | | |
| | LINE SPEED OF 50 mm/min | | | | | | | |
| INSULATING | ELASTIC MODULUS | 1500 | 1500 | 2100 | 1200 | 2300 | 600 | 450 |
| LAYER | (20° C.) [Mpa] | | | | | | | |
| PERFORMANCE | ELASTIC MODULUS | 120 | 120 | 150 | 0.5 | 150 | NEARLY | NEARLY |
| | (150° C.) [Mpa] | | | | | | ZERO | ZERO |
| | DIERECTRIC LOSS TANGENT | 1.7 × | 3.4 × | 2.8 × | 2.8 × | 2.8 × | 2.7 × | 3.0 × |
| | (tan [symbol] ) | 10⁻⁴ | 10⁻⁴ | 10⁻⁴ | 10⁻ [symbol] | 10⁻ [symbol] | 10⁻ [symbol] | 10⁻ [symbol] |
| ELECTRIC | LONG-TERM HEAT | 98 C | 115 A | 110 A | 114 A | 106 A | 111 A | 109 A |
| WIRE | RESISTANCE(10000 hours) [° C.] | | | | | | | |
| PERFORMANCE | LONG-TERM HEAT | C | A | A | A | C | A | A |
| | RESISTANCE(3000 hours) [° C.] | | | | | | | |
| | BENDING PERFORMANCE [N] | 0.80 | 0.86 | 1.10 | 0.70 | 1.30 | 0.49 | 0.45 |
| | | A | A | B | A | B | A | A |
| CABLE | TRANSMISSION LOSS [dB/m] | −2.9 | −4.5 | −3.7 | −3.8 | −3.8 | −3.6 | −3.9 |
| PERFORMANCE | | A | B | A | A | A | A | A |
| | HEAT DEFORMATION RESISTANCE | 3 | 2 | 1 | 11 | 2 | UNMEA- | UNMEA- |
| | (150° C.) [%] | | | | | | SURABLE | SURABLE |
| | | A | A | A | B | A | B | B |

[symbol]

indicates data missing or illegible when filed

From the results of Table 1 and Table 2, the insulated electric wires including insulating layers of No. 1 to No. 11 in which the resin component was block polypropylene, the ethylene unit content of the resin component was 0.5 mol % to 25.0 mol % relative to total monomeric units, the antioxidant had a hindered phenol structure, the content of the antioxidant was 0.05 parts by mass to 0.50 parts by mass relative to 100 parts by mass of the resin component, the copper corrosion inhibitors bad a triazole structure, a hydrazide structure, or a hydrazine structure, and the content of the copper corrosion inhibitors was 0.05 parts by mass to 0.50 pants by mass relative to 100 parts by mass of the resin component had excellent long-term heat resistance and bending property. In addition, the Twinax cables including insulating layers of No. 1 to No. 11 had low transmission loss and excellent heat deformation resistance.

On the other hand, No. 12 in which the content of the antioxidant was less than 0.05 parts by mass and the content of the copper corrosion inhibitors was less than 0.05 parts by mass was inferior in 10000-hour and 3000-hour long-term heat resistance in the electric wire. For No. 13 in which the content of the antioxidant was more than 0.50 parts by mass and the content of the copper corrosion inhibitors was more than 0.50 parts by mass, the transmission loss of the cable was large. No. 14 in which the ethylene unit content of the resin component was less than 0.5 mol % relative to total monomeric units had poor bending performance in the electric wire. For No. 15 in which the ethylene unit content of the resin component was more than 25.0 mol % relative to total monomeric units, the heat deformation resistance of the cable was large. No. 16 in which the resin component contained homopolypropylene was inferior in 3000-hour long-term heat resistance and bending performance in the electric wire. No. 17 in which the resin component contained random polypropylene and No. 18 in which the resin component contained polyethylene had poor heat deformation resistance in the cables to the extent that the heat deformation resistance could not be measured.

From the above, it can be seen that the insulated electric wire of the present disclosure has heat resistance, and is excellent in transmission loss reduction effect and bending property.

### REFERENCE SIGNS LIST

1, 11 insulated electric wire
1a first insulated electric wire
1b second insulated electric wire
2 conductor
2a first conductor
2b second conductor
3 insulating layer
3a first insulating layer
3b second insulating layer
3c third insulating layer
4 coaxial cable
5 external conductor
6, 50, 51 jacket layer
8 drain wire
10, 12 Twinax cable
14 subunit
20 multicore cable
30 shielding tape

1. An insulated electric wire comprising:
a linear conductor; and
an insulating layer stacked on an outer peripheral surface of the conductor,
wherein the insulating layer includes a resin component, an antioxidant, and a copper corrosion inhibitors,
the resin component is a block polypropylene,
an ethylene unit content of the resin component is 0.5 mol % to 25.0 mol % relative to total monomeric units,
the antioxidant has a hindered phenol structure,
a content of the antioxidant is 0.05 parts by mass to 0.50 parts by mass relative to 100 parts by mass of the resin component,
the copper corrosion inhibitors has a triazole structure, a hydrazide structure, or a hydrazine structure, and
a content of the copper corrosion inhibitors is 0.05 parts by mass to 0.50 parts by mass relative to 100 parts by mass of the resin component.

2. An insulated electric wire comprising:
a plurality of linear conductors; and
an insulating layer stacked on an outer peripheral surface of each of the plurality of linear conductors,
wherein the insulating layer includes a resin component, an antioxidant, and a copper corrosion inhibitors,
the resin component is a block polypropylene,
an ethylene unit content of the resin component is 0.5 mol % to 25.0 mol % relative to total monomeric units,
the antioxidant has a hindered phenol structure,
a content of the antioxidant is 0.05 parts by mass to 0.50 parts by mass relative to 100 parts by mass of the resin component,
the copper corrosion inhibitors has a triazole structure, a hydrazide structure, or a hydrazine structure, and
a content of the copper corrosion inhibitors is 0.05 parts by mass to 0.50 parts by mass relative to 100 parts by mass of the resin component.

3. The insulated electric wire according to claim 1,
wherein a molecular weight of the antioxidant is 400 or more, and a molecular weight of the copper corrosion inhibitors is 500 or less.

4. The insulated electric wire according to claim 1,
wherein a melt flow rate of the insulating layer is 0.10 g/10 minutes to 10.00 g/10 minutes.

5. The insulated electric wire according to claim 1,
wherein the insulating layer has an elastic modulus of 2000 MPa or less at 20° C., an elastic modulus of 1 MPa or more at 150° C., and a dielectric loss tangent of 3.0×10⁻⁴ or less at 10 GHz.

6. The insulated electric wire according to claim 1,
wherein the insulating layer stacked on the outer peripheral surface of the conductor or each of the plurality of conductors includes a plurality of insulating layers.

7. An information transmission cable comprising:
one or a plurality of insulated electric wires each being the insulated electric wire according to claim 1.

8. The insulated electric wire according to claim 2,
wherein a molecular weight of the antioxidant is 400 or more, and a molecular weight of the copper corrosion inhibitors is 500 or less.

9. The insulated electric wire according to claim 2,
wherein a melt flow rate of the insulating layer is 0.10 g/10 minutes to 10.00 g/10 minutes.

10. The insulated electric wire according to claim 2,
wherein the insulating layer has an elastic modulus of 2000 MPa or less at 20° C., an elastic modulus of 1 MPa or more at 150° C., and a dielectric loss tangent of 3.0×10⁻⁴ or less at 10 GHz.

11. The insulated electric wire according to claim 2,
wherein the insulating layer stacked on the outer peripheral surface of the conductor or each of the plurality of conductors includes a plurality of insulating layers.

12. An information transmission cable comprising:
one or a plurality of insulated electric wires each being the insulated electric wire according to claim 2.
